(19) United States
(12) Patent Application Publication
(10) Pub. No.: US 2023/0154182 A1
(43) Pub. Date: May 18, 2023

(54) TREE IMAGE DATA ACQUISITION

(71) Applicant: GRACE AND KOWLOON HOLDINGS LIMITED, Central Hong Kong (HK)

(72) Inventor: Nicholas Albert MUIR, Central Hong Kong (HK)

(73) Assignee: GRACE AND KOWLOON HOLDINGS LIMITED, Central Hong Kong (HK)

(21) Appl. No.: 17/995,405

(22) PCT Filed: Apr. 1, 2021
(86) PCT No.: PCT/IB2021/052716

§ 371 Date: Oct. 3, 2022

(30) Foreign Application Priority Data
Apr. 2, 2020 (NZ) 763116

(51) Int. Cl. G06V 20/10; G06V 20/17; G06V 10/44; G06V 10/26; H04N 7/18; G05D 1/00

(52) U.S. Cl. CPC G06V 20/188; G06V 20/17; G06V 10/44; G06V 10/26; H04N 7/185; G05D 1/0094

(57) ABSTRACT

A method comprising: providing a unique identification code corresponding to a single tree; acquiring aerial image data, the aerial image data comprising image data of the tree; extracting the image data of the tree; and providing the image data of the tree to a client associated with the unique identification code.

### FIELD

This relates to approaches for tree image data acquisition.

### BACKGROUND

The forestry industry involves growing multiple trees within forestry zones. There are different approaches for monitoring individual trees within the forestry zone. For example, a person can periodically visit each tree in the forestry zone to obtain data about the tree. This can be slow and labour-intensive.

### SUMMARY

In a first example embodiment, there is provided a method comprising: providing a unique identification code corresponding to a single tree; acquiring aerial image data, the aerial image data comprising image data of the tree; extracting the image data of the tree; and providing the image data of the tree to a client associated with the unique identification code.

### BRIEF DESCRIPTION OF DRAWINGS

The description is framed by way of example with reference to the drawings which show certain embodiments. However, these are provided for illustration only, and do not define or limit the scope of the claims.

FIG. 1 shows an example system in which the disclosed approaches can be used.

FIG. 2 shows an example approach for generating and assigning a unique identification code to a tree.

FIG. 3 shows an example approach for controlling an unmanned aerial vehicle (UAV).

FIG. 4A shows an example of how quality may be influenced after a first pass of a UAV.

FIG. 4B shows an example of how quality may be used to adjust the flight of a UAV in a second pass.

FIG. 5 shows an example approach for extracting image data of a tree from aerial image data.

### DETAILED DESCRIPTION OF DRAWINGS

In one embodiment, each tree in a forestry zone is provided with a unique identification code based on its location. A UAV obtains aerial image data, and a server extracts image data relating to each tree. The server can then provide this to clients associated with the unique identification code of the tree.

This allows for image data of trees in a forestry zone to be obtained automatically and for a client to monitor individual trees within the forestry zone. This can assist in monitoring the trees.

### System

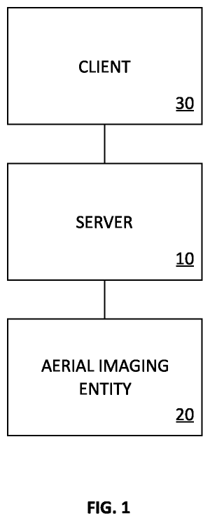

FIG. 1 shows an example system in which this can be implemented.

A server 10 communicates with one or more aerial imaging entities 20. In particular, the one or more aerial imaging entity 20 may comprise one or more unmanned aerial vehicles (UAVs).

The aerial imaging entities 20 are configured to obtain aerial image data from a forestry zone. The forestry zone comprises one or more trees. Each tree is provided with a unique identification code which allows for the unique identification of the corresponding tree.

The aerial imaging entities 20 are in communication with the server 10. For example, this might be a wireless network (such as Wi-Fi) or a cellular network (such as 4G or 5G). In use, the aerial imaging entity 20 obtains aerial image data of the forestry zone using an imaging apparatus. This aerial image data is transmitted to the server 10. This transmission may occur in real-time (that is, within a reasonably short time after being obtained) or may occur when the aerial imaging entity 20 completes its flight.

The server 10 extracts image data of individual trees from the aerial image data. The image data comprises one or more images and optionally metadata.

The server 10 is in communication with one or more clients 30. Each client 30 may comprise a computer system or mobile device configured with appropriate software. In one example, the client 30 is an app on a mobile device of a user.

The image data of each tree is provided to one or more clients 30. The clients 30 may be associated with the tree. This can occur by the client 30 registering, with the server, the unique identification code corresponding to the tree. In this way, the client 30 can obtain image data of a tree.

### Unique Identification Codes

Each tree has a unique identification code. The identification code may be generated, and be regenerable, based on information inherent to the tree. For example, the identification code may be based on the location of the tree. This is because the location of a tree is expected to be consistent over time. There is consequently a one-to-one relationship between an identification code and a tree.

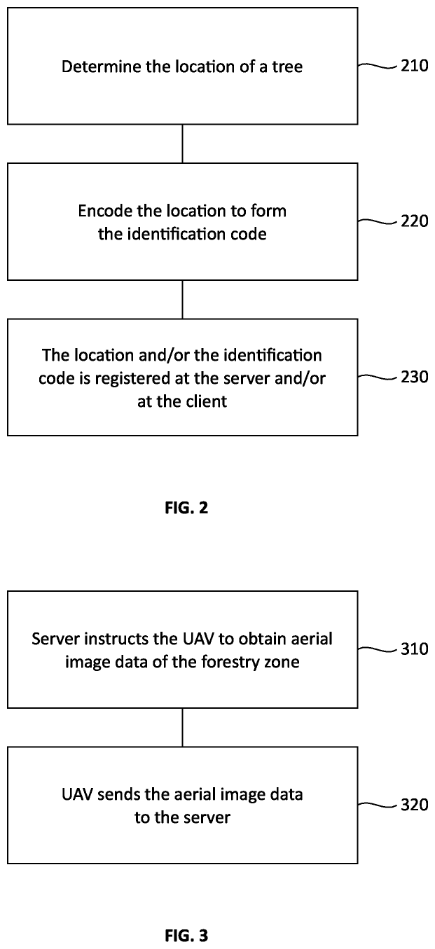

One approach for generating and assigning a unique identification code to a tree is shown in FIG. 2.

At step 210, the location of a tree is determined. This may involve the use of a location sensor that determines a location based on a GNSS arrangement such as GPS. The location may be rounded to within a threshold level of accuracy, such as within 1 metre of the actual location. This allows for slightly inconsistent location measurements over time to be mapped to the same canonical location. This level of accuracy may be based on the likely spacing of trees to avoid the measurements being mapped to the wrong tree.

In some cases, the location comprises a latitude and a longitude of the tree (which may each be rounded to within the threshold level of accuracy).

For newly planted trees, the location may be determined at planting. For existing trees, a person may put a location sensor adjacent the tree to determine its location. Because the location of a tree is not expected to change significantly over time, the location can be treated as invariable. Consequently, once the location of a tree has been determined, it may be stored for subsequent use without the need for repeating the use of a location sensor.

At step 220, the location is encoded to form the identification code. First, the longitude and latitude are concatenated to form a string. Further data may be included in the string, such as padding, a salt, a version identifier, or other data. The string may then be encrypted, for example using public key cryptography, to obscure the relationship between the location and the string. The string may have a bit limit, depending on the encoding scheme used.

The identification code is then encoded according to a predetermined encoding scheme. The encoding scheme may have a level of error detection or error correction and may be selected such that the identification code is a visual representation. For example, the encoding scheme may result in a QR code.

This encoding process is symmetric. That is, it is possible to invert each step of the encoding process to obtain the location from the identification code. In this manner, a user with access to an identification code (and optionally with any necessary decryption keys) could determine the location of the corresponding tree.

In this manner, each tree can be uniquely identified by an identification code and each identification code can be decoded to obtain the location of a tree (and by extension, the tree at that location).

At step 230, the location and/or the identification code is registered at the server and/or at the client. This allows the server and/or the client to maintain a register of which locations have a tree. Where the location is symmetrically encoded to form the identification code, the server and/or the client may only store one of the location and the identification code, since the other is calculable.

In some cases, step 230 may be omitted. For example, it may be unnecessary or undesirable in some cases to maintain a repository of trees.

As the result of the method of FIG. 2, an individual tree within a forestry zone can be provided with unique identification code. Because this is intrinsically linked to the individual tree and therefore can be used to subsequently identify that tree.

### Obtaining Aerial Image Data

The aerial image data is obtained by one or more aerial imaging entities, such as UAVs provided with imaging apparatus.

FIG. 3 shows an example of how an unmanned aerial vehicle (UAV) can be controlled. Such an approach may be equally applicable to other types of aerial imaging entity.

At step 310, the UAV is instructed to obtain aerial image data of the forestry zone.

This may comprise calculating a series of paths over the forestry zone that are expected to allow the imaging apparatus of the UAV to obtain aerial image data of the entire forestry zone.

In some cases, the UAV may be instructed to obtain aerial image data of a number of particular trees. These trees may be identified by the unique identification code associated with the tree and/or by the location of the tree. The paths of the UAV may therefore be calculated to cover each of the identified trees.

The aerial image data may be a video or other stream of images that reflects the path of the UAV. Alternatively, the aerial image data may be a sequence of still images.

In either case, the aerial image data has one or more locations associated with it. The location reflects where the aerial image data corresponds to, and may comprise a longitude and latitude, and optionally an altitude. Where the aerial image data is a video, the aerial image data may have a sequence of locations associated with different parts of the video. Where the aerial image data is a sequence of still images, each image may be a single location associated with it. If the imaging apparatus is pointed directly downwards, the location of the image may be identical to the location of the UAV at the time the image was taken. If the imaging apparatus is angled, the location of the image may be calculated as a function of the orientation of the imaging apparatus and the location of the UAV.

The location of aerial image data may further be calculated based on one or more waypoints with known locations. This may provide a reference location to allow multiple portions of the aerial image data to be combined.

At step 320, the UAV sends the aerial image data to the server.

The aerial image data may be sent continuously while being obtained at step 310, periodically (such as at the particular points of the path of the UAV), or at the completion of its flight. In preferred cases, the aerial image data is sent in real-time. Real-time does not necessarily mean instantly. Real-time may mean within a short time after the aerial image data has been obtained, for example, within minutes of the aerial image data being obtained.

### Quality

In some embodiments, the UAV may continue to operate until it has sufficient aerial image data. To this end, the server may calculate the quality of the aerial image data with respect to each tile of the forestry zone. The UAV may continue to obtain aerial image data until the quality of the aerial image data of every tile of the forestry zone is above a threshold.

In some cases, the quality may be directly calculated on the UAV. This can allow the UAV to adjust its flight or the position of its imaging apparatus immediately.

The quality may depend on the clarity of the tree within the image. For example, an image taken from a first direction may cause the shadow of the UAV to obscure part of the tree. Alternatively, a neighbouring tree may obscure the image of the tree. These may result in a low quality for the corresponding tile.

Where it is intended to provide a 3-dimensional representation of the tree, it may be necessary to obtain images from different sides of the tree. The quality may therefore further reflect whether there is sufficient aerial image data to form the 3-dimensional representation.

On the basis of the quality, the UAV's route and/or the position of the imaging apparatus may be adjusted to obtain one or more further images of the low-quality tiles. The adjustment may be calculated by the UAV directly or by the server and sent to the UAV.

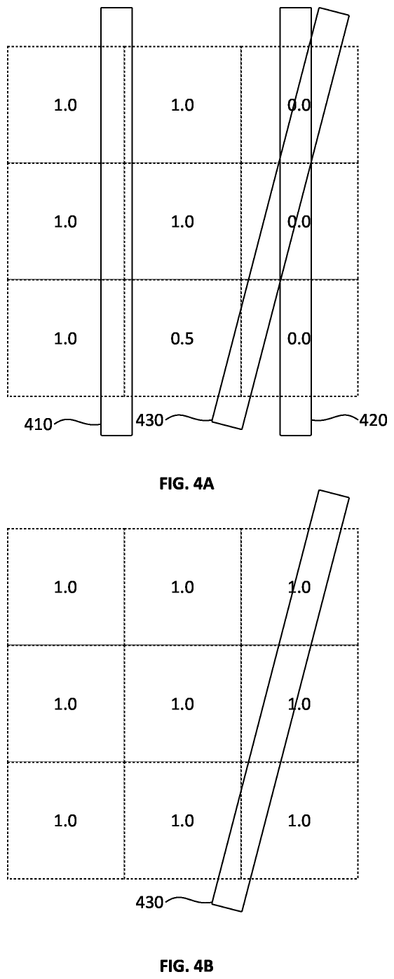

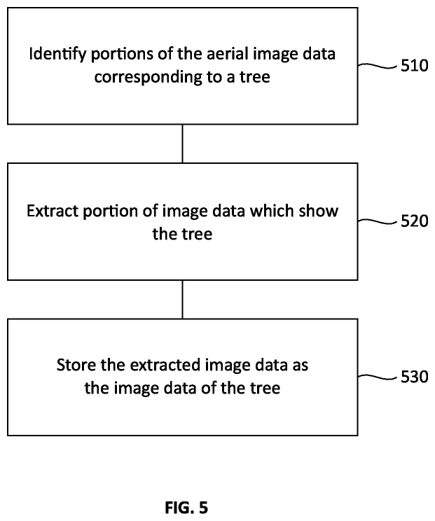

FIGS. 4A and 4B shows an example of how the quality may be used to adjust the flight of a UAV. In this case, each tile has an initial quality of 0 (indicating that there is no aerial image data of the corresponding tile). The threshold quality is 1 (indicating that there is sufficient aerial image data for the corresponding tile).

FIG. 4A shows the result of a first pass by the UAV along path 410. Certain tiles have a quality of 1, which indicates that a sufficient quality image was obtained for those tiles.

Path 420 indicates an initial calculation of a second pass over the tiles by the UAV. Path 420 may have been calculated before the UAV flight began. However, because of the quality of the aerial image data obtained after the first pass, a new path 430 is calculated. Path 430 is expected to provide a higher quality for the tiles than initial path 420.

FIG. 4B shows the result of the second pass by the UAV along path 430. This shows that all the tiles have a quality of 1. This means there is sufficient aerial image data for each tile, and so no further aerial image data is required.

In some cases, a display may be updated to show the position of the UAV with respect to the tiles of the forestry zone. This display may also show the quality of the aerial image data for each data and/or the extracted image data for the tree of each tile. This display may be updated in real-time to allow for real-time tracking of the UAV.

### Extracting Image Data of the Tree

For the purpose of aerial image data, the forestry zone can be encoded as a tessellation comprising a plurality of tiles, where each tile holds a single tree. The shape, size, and distribution of the tiles within the tessellation depends on the distribution of trees within the forestry zone.

In many managed forestry zones, trees are planted in a regular grid. In such a case, the tessellation of the forestry zone may be a grid of equally sized square tiles. Where the forestry zone is a natural or unmanaged forest, the trees may be irregular. In such a case, each point within the forestry zone may form part of the tile corresponding to the tree closest to the point. In this manner, the tessellation may be a Voronoi tessellation. Because each tile holds a single tree, the identification code for the tree may be treated as an identification code for the tile.

To obtain aerial image data of a tile, multiple sources of aerial image data may be overlaid or combined. For example, each pass of the UAV may provide a portion of the overall tile.

Once aerial image data has been gathered by the UAV, this is be transmitted to the server. This transmission can occur in real-time. Real-time does not necessarily mean instantly. Real-time may mean within a short time after the aerial image data has been gathered, for example, within minutes of the aerial image data being obtained. The aerial image data may be streamed to the server as a constant feed as the aerial image data is obtained. Alternatively, the aerial image data may be sent as discrete units. The server can then extract image data of individual trees from the aerial image data.

FIG. 5 shows one approach for extracting image data of a tree from aerial image data.

At step 510, the server identifies portions of the aerial image data corresponding to a tree. This occurs through the location associated with the aerial image data. For still images in the aerial image data, this may comprise determining if the location of the still image matches the location of a tree. For a stream of images (such as a video), this may comprise determining if the location of a portion of the stream matches the location of a tree.

At step 520, the server extracts portions of image data which show the tree. This may involve cropping parts of the aerial image data to show only the desired tree. In some cases, the server may combine multiple portions of the aerial image data to form the image data of the tree. For example, if multiple still images each show different parts of a tree, these multiple still images could be combined. The combination may comprise overlaying or interpolation.

Extracting the image data may comprise using the altitude of the aerial image data, the latitude of the aerial image data, the longitude of the aerial image data. These may be passed to an appropriately enabled image recognition module, such as a trained neural network. This can allow the server to calculate what part of the tree is shown in a particular extracted image data based on the location of the corresponding aerial image data.

The server may use the tree spacing to avoid showing neighbouring trees in the image data. For example, if the trees have a four-metre spacing, the server may ensure that the image data shows only two metres around the tree.

The server may generate the image data of the tree based on a desired output geometry. For example, the server may be configured to extract the tile corresponding to the tree, or to extract a square image.

At step 530, the server stores the extracted image data as the image data of the tree. The image data can be associated with the unique identification code by the server. This allows the server to respond to a request for image data of a tree identified by the unique identification code with the corresponding image data.

In this manner, the server can automatically identify and extract image data of a tree from aerial image data of a forestry zone.

### Providing to a Client

Once the server has obtained image data of a tree, the server provides the image data to a client. The provision may take two forms.

In a first form, the server sends the image data to the client. This may occur in real-time relative to the aerial image data being gathered and the image data of the tree being extracted. In this case, the client may have previously registered with the server as being associated with a particular tree. This may occur by the client sending the unique identification code of the tree to the server.

In a second form, the server makes the image data available to the client. This may be in response to a request at the server by the client for new image data. In this manner, the server may make an API available for the client to use for requests. In this case, the image data may be made available to the client in real-time, but the client may not receive the data until a time much later when the client requests the data.

A combination of these approaches may be used. For example, the server may send a notification to the client in real-time that image data has been made available. This notification may not include the image data. The image data can then be obtained by the client through a subsequent request to the server.

In any case, while real-time may mean immediately, it is not limited to this: real-time may mean within minutes or hours of the aerial of the image data becoming available.

In addition to the server providing the image data to the client, the server may provide metadata related to the image data. The metadata may include one or more of: the time that the underlying aerial image data was obtained, an identification of the UAV which obtained the aerial image data, and characteristics of the tree. The metadata may additionally or alternatively include any other metadata related to the tree.

In some cases, the server may require that the client is authenticated before the image data is provided to the client. This may occur using a username or password. Alternatively, in some cases the possession of the unique identification code of the tree may be regarded as sufficient authentication.

As the result of providing the image data to the client, the client can view the tree in real-time.

### Interpretation

A number of methods have been described above. Any of these methods may be embodied by a series of instructions which may form a computer program. These instructions, or this computer program, may be stored on a computer-readable medium, which may be non-transitory. When executed, these instructions or this program may cause one or more processors to perform the described methods.

Where an approach has been described as being implemented by a processor, this may comprise a plurality of processors. That is, at least in the case of processors, the singular should be interpreted as including the plural. Where methods comprise multiple steps, different steps or different parts of a step may be performed by different processors.

The order of steps within methods may be altered, such that steps are performed out of order or in parallel, except where one step is dependent on another having been performed, or the context otherwise requires.

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments and with reference to the drawings, the invention is not intended to be restricted to such details. Additional advantages and modifications will readily appear to those skilled in the art. Therefore, the invention in its broader aspects is not limited to the specific details, representative apparatuses and methods, and illustrative examples shown and described. Accordingly, departures may be made from such details without departure from the spirit or scope of the general inventive concept.

1. A method comprising:
providing a unique identification code corresponding to a single tree;
acquiring aerial image data, the aerial image data comprising image data of the tree;
extracting the image data of the tree; and
providing the image data of the tree to a client associated with the unique identification code.

2. The method according to claim 1, wherein the unique identification code comprises a first part corresponding to the longitude of the tree and a second part corresponding to the latitude of the tree.

3. The method according to claim 1, wherein acquiring aerial image data comprises using an imaging apparatus on an unmanned aerial vehicle (UAV).

4. The method according to claim 3, wherein the UAV is configured to identify the tree based on the unique identification code.

5. The method according to claim 4, wherein the UAV is configured to adjust its position to reach a threshold image quality.

6. The method according to claim 1, wherein relaying the unique identification code and the image data of the tree to a mobile application comprises:
transmitting the image data to an external server, wherein the external server is configured to transmit the image data to the client.

7. The method according to claim 1, wherein extracting the image data comprises using one or more of a tree spacing, a desired output geometry, the altitude of the aerial image data, the latitude of the aerial image data, or the longitude of the aerial image data to crop a subset of the input image data that contains only a single tree according to the desired output geometry.

8. The method according to claim 7, wherein the desired output geometry is a square.

9. The method according to claim 8, further comprising:
identifying a digital grid representation comprising squares, each containing a single tree of a uniformly planted region.

10. The method according to claim 9, wherein one or more of: a flying path or the current location of the UAV are superimposed over the grid representation and displayed, thereby allowing real-time tracking of the UAV with reference to the positions of the one or more trees depicted by the grid.

11. (canceled)

12. (canceled)

13. A non-transitory computer readable medium comprising instructions which, when executed by one or more processors, cause the one or more processors to perform a method comprising:
providing a unique identification code corresponding to a single tree;
acquiring aerial image data, the aerial image data comprising image data of the tree;
extracting the image data of the tree; and
providing the image data of the tree to a client associated with the unique identification code.

14. A system comprising:
a server configured to:
provide a unique identification code corresponding to a single tree;
acquire aerial image data, the aerial image data comprising image data of the tree;
extract the image data of the tree; and
provide the image data of the tree to a client associated with the unique identification code.

15. The system according to claim 14, wherein the unique identification code comprises a first part corresponding to the longitude of the tree and a second part corresponding to the latitude of the tree.

16. The system according to claim 14, wherein the server being configured to acquire aerial image data comprises the server being configured to use an imaging apparatus on an unmanned aerial vehicle (UAV).

17. The system according to claim 16, wherein the UAV is configured to identify the tree based on the unique identification code.

18. The system according to claim 17, wherein the UAV is configured to adjust its position to reach a threshold image quality.

19. The system according to claim 14, wherein the server being configured to extract the image data comprises the server being configured to use using one or more of: a tree spacing, a desired output geometry, the altitude of the aerial image data, the latitude of the aerial image data, or the longitude of the aerial image data to crop a subset of the input image data that contains only a single tree according to the desired output geometry.

20. The system according to claim 19, wherein the desired output geometry is a square.

21. The system according to claim 20, wherein the server is further configured to:
identify a digital grid representation comprising squares, each containing a single tree of a uniformly planted region.

22. The system according to claim 21, wherein one or more of: a flying path or the current location of the UAV are superimposed over the grid representation and displayed, thereby allowing real-time tracking of the UAV with reference to the positions of the one or more trees depicted by the grid.
